(19) United States
(12) Patent Application Publication
(10) Pub. No.: US 2016/0093999 A1
(43) Pub. Date: Mar. 31, 2016

(54) UNIVERSAL MAGNETIC ADAPTER

(71) Applicant: Apple Inc., Cupertino, CA (US)

(72) Inventors: Ronald G. Powers, Scotts Valley, CA (US); Kevin M. Keeler, Los Gatos, CA (US)

(73) Assignee: APPLE INC., Cupertino, CA (US)

(21) Appl. No.: 14/503,208

(22) Filed: Sep. 30, 2014

(51) Int. Cl. H01R 31/06; H01R 13/64; H01R 13/62

(52) U.S. Cl. CPC H01R 31/06; H01R 13/6205; H01R 13/64

(57) ABSTRACT

Circuits, methods, and apparatus that may reduce the number of connector receptacles on an electronic device. Also, connector inserts mated with these receptacles may be easily removed in the event of an inadvertent disconnection. One example may provide a number of adapters, where each adapter may have a receptacle to accept one of a number of connector inserts. Each adapter may also have an insert portion to fit in a connector receptacle on an electronic device, where each of the number of connector inserts may fit in the same connector receptacle.

### BACKGROUND

The number and types of electronic devices available to consumers have increased tremendously the past few years, and this increase shows no signs of abating. Electronic devices, such as portable media players, storage devices, tablets, netbooks, laptops, desktops, all-in-one computers, wearable computing devices, cell, media, and smart phones, televisions, monitors, and other display devices, navigation systems, and other devices have become ubiquitous in recent years.

These devices often receive power and share data using various cables. These cables may have connector inserts, or plugs, on each end. The connector inserts may plug into connector receptacles on electronic devices, thereby forming one or more conductive paths between devices for signals and power.

Some devices may have several such connector receptacles, each receptacle to provide and receive signals and power consistent with a standard interface. As the number of standard interfaces has grown over the past few years, so has the number of connector receptacles along sides of electronic devices.

There are several negative aspects to this proliferation of connector receptacles. The housings for these electronic devices may be arranged to have openings for these receptacles, while traces and interconnect on a board or other substrate in the device may be arranged to connect to pins or contacts in the receptacle. Also, the number of receptacles may have deleterious effect on the appearance of an electronic device. These factors may increase costs and complexity of a device making it less appealing in the marketplace.

Also, cables having inserts inserted in these device receptacles may experience inadvertent forces. As an example, they may be tripped over, pulling the device to the floor. Accordingly, it may be desirable that the connector inserts be easily disengaged from the connector receptacles.

Thus, what is needed are circuits, methods, and apparatus that may reduce the number of connector receptacles on an electronic device. It may also be desirable that connector inserts mated with these receptacles are easily removed in the event of an inadvertent force.

### SUMMARY

Accordingly, embodiments of the present invention may provide circuits, methods, and apparatus that may reduce the number of connector receptacles on an electronic device. Also, connector inserts mated with these receptacles may be easily removed in the event of an inadvertent force.

An illustrative embodiment of the present invention may provide a number of adapters, where each adapter may have a receptacle portion to accept one of a number of different types of connector inserts. Each adapter may have an insert portion to fit in a corresponding connector receptacle on an electronic device, where each of the number of connector inserts may fit in the same connector receptacle. That is, each adapter may have the same shaped insert portion and the contacts on the insert portions may have the same arrangement, thought it should be noted that the signals carried by the contacts on the insert portions may vary among the adapters.

In this way, each corresponding connector receptacle in the electronic device may be used as a receptacle for one of a number of interfaces. This may reduce the number of types of connector receptacles on an electronic device since each corresponding connector receptacle may be able to handle different types of interfaces. Also, the number of connector receptacles needed for an electronic device may be reduced as well. That is, since each corresponding connector receptacle may be able to handle a different type of interface, the number of unused or rarely used connector receptacles may be reduced. For example, a conventional device may include two types of video connectors. An embodiment of the present invention may provide adapters for each type of video connector and a device receptacle to accept the adapters. This may reduce the need for video connectors on a device from two to only one.

In various embodiments of the present invention, one or more of the adapters may be rotatable. That is, an adapter may be inserted in either of at least two orientations in a connector receptacle of a device. This may simplify the connection process performed by users. In these and other embodiments of the present invention, one or more other adapters may be arranged such that they may be inserted in a connector receptacle in a single direction. These adapters may include a keying arrangement to prevent the insertion of the adapter into a connector receptacle in an improper or upside-down orientation. In some embodiments of the present invention, some adapters may be rotatable and not include a keying feature, while others may not be rotatable and may include a keying feature. Other embodiments may include only adapters that are rotatable and do not include a keying feature, while others may include only adapters that are not rotatable and do include a keying feature. In these and other embodiments of the present invention, the receptacle side of one or more adapters may be rotatable as well. For example, connector inserts of one or more standards may be rotatable as part of the standard itself.

In various embodiments of the present invention, receptacles on an electronic device may be able to determine which adapter has been inserted. This may be done by placing a ground or other type of pin at a specific contact on the insert portion of an adapter. For example, a first type of video connector adapter may have ground at a first pin of its insert portion, while a second type of video connector may have a ground at a second pin of its insert portion. This and other techniques may be used to enable a device to determine which adapter has been inserted. This and other techniques may be used with rotatable adapters to determine in which orientation an adapter has been inserted. In still other embodiments of the present invention, once a connector receptacle in an electronic device determines that an adapter has been inserted, a prompt may appear asking a user what kind of adapter has been inserted. In a specific embodiment of the present invention, two pins in a specific group of two or more pins on a rear of an adapter may be connected to each other. The receptacle may detect that the two corresponding pins in its receptacle are connected together when the adapter is inserted. The receptacle may be able to tell the identity of the adapter from which two pins are connected. In other embodiments, the same two pins may be connected on each adapter, and this information may be used to indicate that an insert has been inserted and the device may prompt a user for its identity.

Contacts in the receptacle portion of an adapter may connect to contacts on the insert portion of the adapter in different ways. These connections may be direct, point-to-point connections. That is, a contact in the receptacle portion may directly connect to a contact on the insert portion. Other contacts, such as power or ground contacts in the receptacle portion may connect to more than one contact on the insert portion. Also, typically each contact in the receptacle portion may electrically connect to one or more contacts in the connector receptacle in the device. This may improve current carrying capabilities of the adapters. However, not all contacts in the connector receptacle in the device may connect to a contact in the receptacle portion of the adapter. For example, one interface may have only four receptacle contacts while another may have 30 contacts. Most, if not all, of the contacts in the connector receptacle may be electrically connected to contacts in the receptacle of the 30-pin adapter, while a fewer number may be electrically connected to contacts in the receptacle of the four pin-adapter.

In other embodiments of the present invention, contacts in the connector receptacle in the electronic device may be connected to a contact in an adapter receptacle for only one adapter. In this way, there may be 30 pins in the connector receptacle in the device that connect to 30 pins in receptacle portion of the 30-pin adapter and there may be four different pins in the connector receptacle in the device that connect to four pins in the receptacle portion of the four-pin adapter. In other embodiments, signals may be grouped by type to share pins in order to reduce the number of pins in the connector receptacle in the device. For example, a differential input signal for one interface may share pins with another differential input signal for another interface.

Embodiments of the present invention may provide adapters that may readily breakaway from a connector receptacle in an electronic device. These adapters and receptacles may be held together by one or more magnets. When an inadvertent force pulls on a cable attached to a connector insert that has been inserted in the adapter, the adapter may readily breakaway from the electronic device receptacle, thereby preventing damage to the electronic device. In various embodiments of the present invention, one or more magnets may be located in either or both the adapter or receptacle. Ferromagnetic material may be used in either the adapter or receptacle in place of, or along with, the one or more magnets. In this way, magnetic attraction may be used to keep an adapter in place in a connector receptacle in an electronic device.

These adapters may have various shapes to facilitate them being readily disengaged from a connector receptacle in the event of an inadvertent disconnection. While various shapes may be used by different groups of inserts, typically each adapter in a group of inserts may have a consistently shaped insert portion. In one specific example, each adapter may have a front face having an opening for a connector receptacle. Each adapter may also have a rear face, where the rear face includes a rear curved face forming an arc from a left edge of the front face of the adapter to a right edge of the front face of the adapter, a top surface downwardly sloping from a top edge of the front face of the adapter to a top of the rear curved surface, and a bottom surface upwardly sloping from a bottom edge of the front face of the adapter to a bottom of the rear curved surface.

In various embodiments of the present invention, the components of the adapters and receptacles may be formed in various ways of various materials. For example, contacts or pins, interconnect lines, and other conductive portions of the adapters and receptacles may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the adapter and receptacle housings and other portions, may be formed using injection or other molding, 3-D printing, machining, or other manufacturing process. The nonconductive portions may be formed of silicon or silicone, rubber, hard rubber, plastic, nylon, elastomers, liquid-crystal polymers (LCPs), ceramics, or other nonconductive material or combination of materials.

Embodiments of the present invention may provide adapters and receptacles that may be located in, and may connect to, various types of devices, such as portable computing devices, tablet computers, desktop computers, laptops, all-in-one computers, wearable computing devices, cell phones, smart phones, media phones, storage devices, portable media players, navigation systems, monitors, power supplies, adapters, remote control devices, chargers, and other devices. These adapters and connector receptacles may provide pathways for signals that are compliant with various standards such as Universal Serial Bus (USB), USB2, USB3, USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these adapters and connector receptacles may be used to convey power, ground, signals, test points, and other voltage, current, data, or other information.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates an adapter and a connector receptacle according to an embodiment of the present invention;

FIG. 2 illustrates a side view of an adapter and a connector receptacle according to an embodiment of the present invention;

FIG. 3 illustrates a front view of an adapter according to an embodiment of the present invention;

FIG. 4 illustrates a connector adapter system according to an embodiment of the present invention;

FIG. 5 illustrates signal paths through an adapter and a connector receptacle according to an embodiment of the present invention;

FIG. 6 illustrates a connector adapter breaking away from a connector receptacle according to an embodiment of the present invention; and

FIG. 7 illustrates a connector adapter breaking away from a connector receptacle according to an embodiment of the present invention.

### DESCRIPTION OF ILLUSTRATIVE EMBODIMENTS

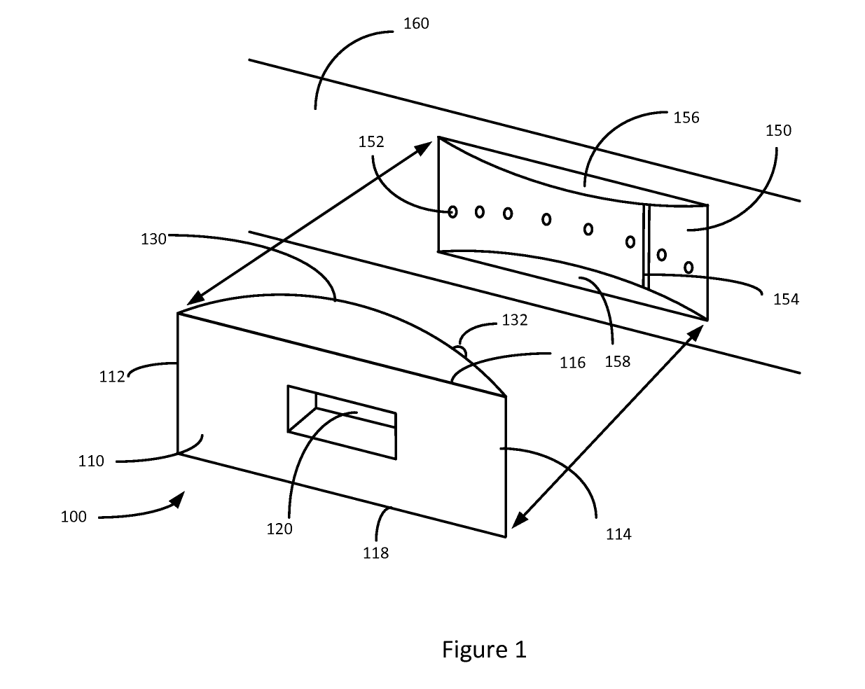

FIG. 1 illustrates an adapter and a connector receptacle according to an embodiment of the present invention. This figure, as with the other included figures, is shown for illustrative purposes and does not limit either the possible embodiments of the present invention or the claims.

This example includes adapter 100. Adapter 100 may have a front face 110. Front face 110 may include an opening 120 for a receptacle portion of the adapter. Front face 100 may have a left edge 112, a right edge 114, top edge 116, and bottom edge 118. Adapter 100 may also include a rear insert portion 130. Rear insert portion 130 of adapter 100 may be inserted into connector receptacle 150 in electronic device 160. Adapter 100 may include contacts in receptacle portion 110 that may electrically connect to contacts on rear insert portion 130. These contacts on rear insert portion 130 may form electrical connections with contacts 152 in receptacle 150.

Receptacle portion 120 of adapter 100 may be arranged to accept connector inserts of a first interface type. This may allow a user to connect a second device using a cable having an insert of the interface type to electronic device 160. Specifically, a user may have adapter 100 or may select adapter 100 from a number of adapters. The user may insert the connector insert attached to a cable into receptacle portion 120 of adapter 100. A user may also insert adapter 100 into receptacle 150 in electronic device 160. A user may instead insert the adapter 100 into receptacle 150 before inserting a connector insert into receptacle portion 120 of adapter 100.

In this example, adapter 100 may be operational in only one orientation in receptacle 150. Accordingly, keying feature 154 in receptacle 150 and keying feature 132 on insert portion 130 of adapter 100 may be included. These keying features may prevent an inadvertent or rotated connection from being formed. Again, other adapters may be rotatable and may not include keying feature 132. For this reason, keying feature 154 on receptacle 150 may accept keying feature 132 on adapter 100. In this way, if keying feature 132 is not present, adapter 100 may still engage receptacle 150 in either of at least two orientations, where the two orientations are 180 degrees apart.

Adapter 100 may have various shapes consistent with embodiments of the present invention. In this example, adapter 100 may have a front face 110 having an opening 120 for a receptacle portion. Adapter 100 may further have a curved or rear face 130. Curved rear insert portion 130 may extend from left edge 112 to right edge 114 of front face 110. Adapter 100 may further have a top downwardly sloping portion 134 that may extend from a top edge 116 to curved rear insert portion 130. Adapter 100 may have a similar bottom surface. Top surface 134 and a bottom surface may mate with surfaces 156 and 158 in receptacle 150.

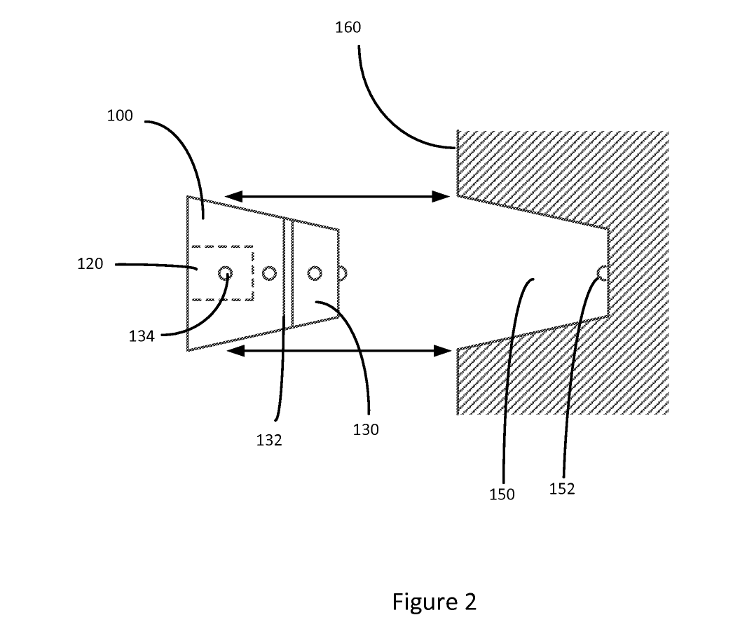

FIG. 2 illustrates a side view of an adapter and a connector receptacle according to an embodiment of the present invention. Adapter 100 may include an insert portion 130. A connector insert, for example a connector insert attached to a cable, maybe inserted in to receptacle portion 120. Adapter 100 may have a rear curved surface forming an insertion portion 130. Insertion portion 130 may include contacts 134 to mate with contacts 152 in connector receptacle 150 in electronic device 160.

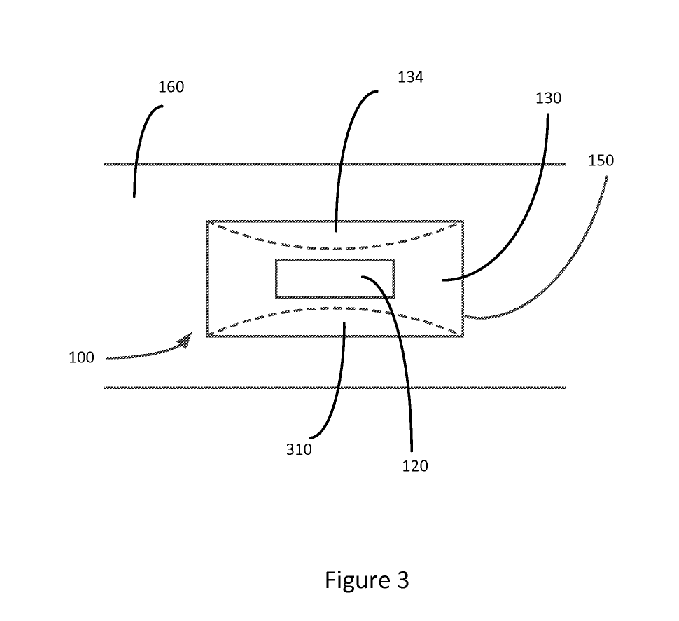

FIG. 3 illustrates a front view of an adapter according to an embodiment of the present invention. Specifically, adapter 100 may be inserted in receptacle 150 in an electronic device 160 according to an embodiment of the present invention. Adapter 100 may have a rear surface 130 bound by a top surface 134 and a bottom surface 310. Adapter 100 may further include a receptacle portion 120. Receptacle portion 120 may accept a connector insert of a first type.

Again, embodiments of the present invention may provide a number of adapters, each adapter having a receptacle portion consistent with a different type of connector insert. An example is shown in the following figure.

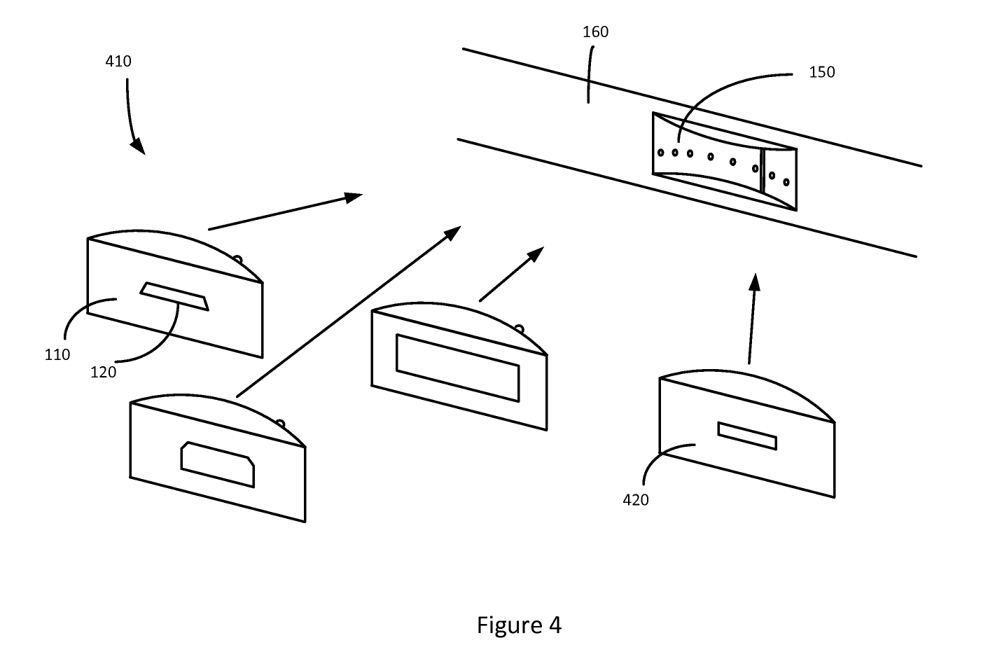

FIG. 4 illustrates a connector adapter system according to an embodiment of the present invention. This system may include a number of adapters 410 each having an opening 120 for a receptacle portion on a front face 110. Each of these adapters may mate with receptacle 150 an electronic device 160. In this way, these various and adapters 410 may be used to provide a connection between a connector insert of one of a number of types with electronic device 160.

In this way, embodiments of the present invention may provide a number of adapters, where each adapter may have a receptacle to accept one of a number of connector inserts. Each adapter may have an insert portion to fit in a corresponding connector receptacle on an electronic device, where each of the number of connector inserts may fit in the same connector receptacle. That is, each adapter may have the same shaped insert portion and the contacts on the insert portion may have the same arrangement.

In this way, each corresponding connector receptacle in the electronic device may be able to be used as a receptacle for one of a number of interfaces. This may reduce the number of types of connector receptacles on an electronic device since each corresponding connector receptacle may be able to handle different types of interfaces. Also, the number of connector receptacles needed for an electronic device may be reduced as well. That is, since each corresponding connector receptacle may be able to handle a different type of interface, the number of unused or rarely used connector receptacles may be reduced. For example, a conventional device may include both an HDMI connector and a Thunderbolt connector. An embodiment of the present invention may provide adapters for each of these connectors and a device receptacle. This may reduce the need for these both of these video connectors to be present on an electronic device and may reduce the number of connectors from two to only one.

Again, various adapters 410 may be rotatable, while others are not rotatable. That is, in various embodiments of the present invention, one or more of the adapters may be rotatable. A rotatable adapter may be inserted in either of at least two orientations in a connector receptacle of a device. This may simplify the connection process performed by users. In these and other embodiments of the present invention, one or more other adapters may be arranged such that they may be inserted in a connector receptacle in a single direction. These adapters may include a keying arrangement to prevent the insertion of the adapter into a connector receptacle in an improper or upside-down orientation. In some embodiments of the present invention, some adapters may be rotatable and not include a keying feature, while others may not be rotatable and may include a keying feature. Other embodiments may include only adapters that are rotatable and do not include a keying feature, while others may include only adapters that are not rotatable and do include a keying feature. In these and other embodiments of the present invention, the receptacle side of one or more adapters may be rotatable as well. For example, connector inserts of one or more standards may be rotatable as part of the standard itself. Accordingly, various adapters in the connector adapter system 410 may include keying features, while others, such as adapter 420, do not.

In various embodiments of the present invention, receptacles on an electronic device may be able to determine which adapter in the connector adapter system 410 has been inserted. This may be done by placing a ground or other type of pin at a specific contact on the insert portion of an adapter. For example, a first type of video connector adapter may have ground at a first pin of its insert portion, while a second type of video connector may have a ground at a second pin of its insert portion. This and other techniques may be used to determine which adapter has been inserted. This and other techniques may be used with rotatable adapters to determine in which orientation an adapter has been inserted. In still other embodiments of the present invention, once a connector receptacle in an electronic device determines that an adapter has been inserted, a prompt may appear asking a user what kind of adapter has been inserted. In a specific embodiment of the present invention, two pins in a specific group of two or more pins on a rear of an adapter may be connected to each other. The receptacle may detect that the two corresponding pins in its receptacle are connected together when the adapter is inserted. The receptacle may be able to tell the identity of the adapter from which two pins are connected. In other embodiments, the same two pins may be connected on each adapter, and this information may be used to indicate that an insert has been inserted and the device may prompt a user for its identity.

Contacts or pins in a receptacle portion of an adapter may be connected through pins of an insert portion of the adapter to contacts in a receptacle in an electronic device in various ways. These connections may be direct, point-to-point connections. That is, a contact in the receptacle portion may directly connect to a contact on the insert portion. Other contacts, such as power or ground contacts in the receptacle portion, may connect to more than one contact on the insert portion. Also, typically each contact in the receptacle portion may electrically connect to one or more contacts in the connector receptacle in the device. However, not all contacts in the connector receptacle in the device may connect to a contact in the receptacle portion of the adapter. For example, a USB interface may have only four receptacle contacts while a Thunderbolt interface may have 20 contacts. Most, if not all, of the contacts in the connector receptacle may be electrically connected to contacts in the receptacle of the Thunderbolt adapter, while a fewer number may be electrically connected to contacts in the receptacle of the USB adapter.

In other embodiments of the present invention, contacts in the connector receptacle in the electronic device may be connected to a contact in an adapter receptacle for only one adapter. In this way, there may be 20 pins in the connector receptacle in the device that are connected to 20 pins in the receptacle portion of the Thunderbolt adapter and there may be four different pins in the connector receptacle in the device that connect to four pins in the receptacle portion of the USB adapter. In other embodiments, signals may be grouped by type to share pins in order to reduce the number of pins in the connector receptacle in the device. For example, a differential input signal for one interface may share pins with another differential input signal for another interface. An example of such interconnect is shown in the following figure.

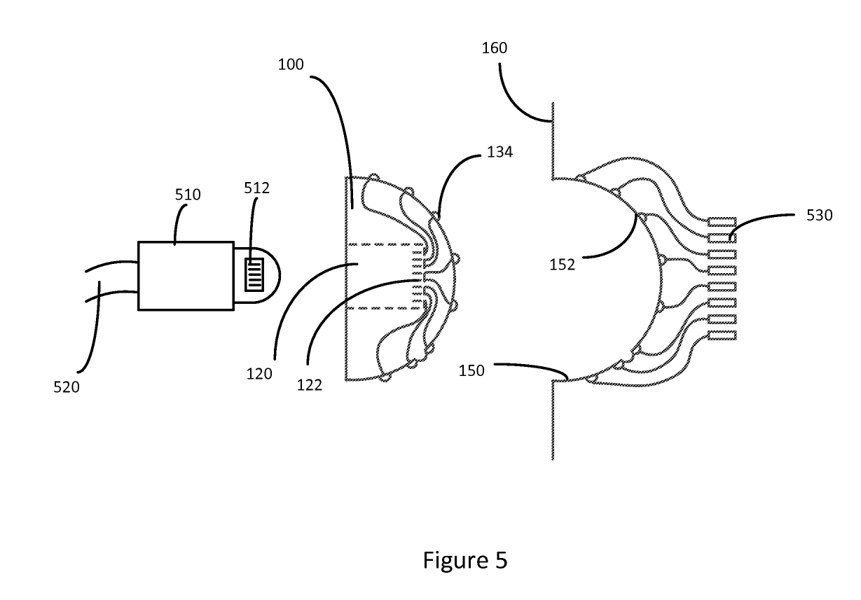

FIG. 5 illustrates signal paths through an adapter and a connector receptacle according to an embodiment of the present invention. Adapter 100 may include a receptacle portion 120 for accepting a connector insert 510. Connector insert 510 may support a number of contacts 512. Contacts 512 may electrically connected to conductors in cable 520. Once connector insert 510 is inserted into adapter 100, contacts 512 may electrically connect to contacts 122 in receptacle portion 120 of adapter 100. Adapter 100 may be inserted into receptacle 150 in electronic device 160. Contacts 134 may electrically connect to contacts 152 in the receptacle 150. Contacts 152 may electrically connect to pads or traces 530 on a printed circuit board or other substrate in an electronic device 160.

Embodiments of the present invention may provide adapters that may readily breakaway from a connector receptacle in an electronic device. These adapters and receptacles may be held together by one or more magnets. When an inadvertent force pulls on a cable attached to a connector insert that has been inserted in the adapter, the adapter may readily breakaway from the electronic device receptacle, thereby preventing damage to the electronic device. In various embodiments of the present invention, one or more magnets may be located in either or both the adapter or receptacle. Ferromagnetic material may be used in either the adapter or receptacle in place of or along with the one or more magnets. In this way, magnetic attraction may be used to keep an adapter in place in a connector receptacle in an electronic device. An example is shown in the following figures.

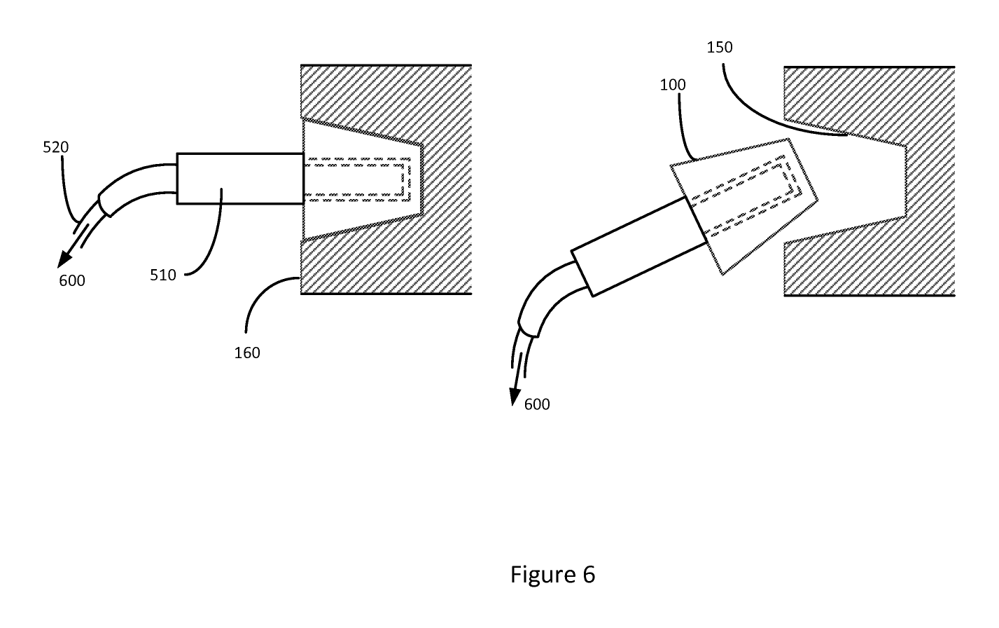

FIG. 6 illustrates a connector adapter breaking away from a connector receptacle according to an embodiment of the present invention. As before, connector insert 510 may be inserted into a receptacle portion in adapter 100. Adapter 100 may be inserted into receptacle 150 in electronic device 160. When a force 600 is applied to cable 520, adapter 100 may be pulled from receptacle 150.

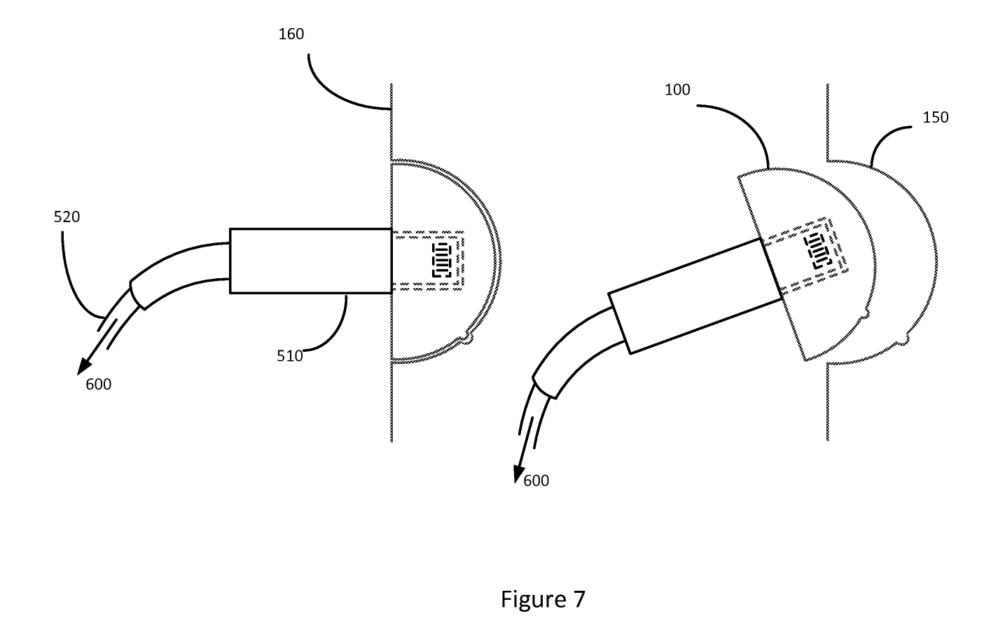

FIG. 7 illustrates a connector adapter breaking away from a connector receptacle according to an embodiment of the present invention. As before, connector insert 510 may be inserted into a receptacle portion in adapter 100. Adapter 100 may be inserted into receptacle 150 in electronic device 160. When a force 600 is applied to cable 520, adapter 100 may be pulled from receptacle 150.

In various embodiments of the present invention, the components of the adapters and receptacles may be formed in various ways of various materials. For example, contacts or pins, interconnect lines, and other conductive portions of the adapters and receptacles may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the adapter and receptacle housings and other portions, may be formed using injection or other molding, 3-D printing, machining, or other manufacturing process. The nonconductive portions may be formed of silicon or silicone, rubber, hard rubber, plastic, nylon, elastomers, liquid-crystal polymers (LCPs), ceramics, or other nonconductive material or combination of materials.

Embodiments of the present invention may provide adapters and receptacles that may be located in, and may connect to, various types of devices, such as portable computing devices, tablet computers, desktop computers, laptops, all-in-one computers, wearable computing devices, cell phones, smart phones, media phones, storage devices, portable media players, navigation systems, monitors, power supplies, adapters, remote control devices, chargers, and other devices. These adapters and connector receptacles may provide pathways for signals that are compliant with various standards such as Universal Serial Bus (USB), USB2, USB3, USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these adapters and connector receptacles may be used to convey power, ground, signals, test points, and other voltage, current, data, or other information.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A plurality of adapters comprising a first adapter and a second adapter,
wherein the first adapter comprises:
a receptacle to receive a connector insert of a first type; and
an insert to mate with a connector receptacle on an electronic device;
wherein the second adapter comprises:
a receptacle to receive a connector insert of a second type, the second type different from the first type; and
an insert to mate with the connector receptacle in the electronic device.

2. The plurality of adapters of claim 1 wherein the first adapter further comprises a first plurality of contacts in the receptacle and the connector receptacle in the electronic device comprises a second plurality of contacts, wherein when the first adapter is inserted in the connector receptacle in the electronic device, each of the first plurality of contacts is electrically connected at least one of the second plurality of contacts, and at least one of the second plurality of contacts is not electrically connected to any of the first plurality of contacts.

3. The plurality of adapters of claim 1 wherein the first adapter comprises a magnet.

4. The plurality of adapters of claim 1 wherein the connector receptacle in the electronic device comprises a magnet.

5. The plurality of adapters of claim 1 wherein each of the plurality of adapters includes a keying feature on the insert.

6. The plurality of adapters of claim 1 wherein the receptacle of the first adapter may receive a universal serial bus insert.

7. A plurality of adapters comprising a first adapter and a second adapter,
wherein the first adapter comprises:
a receptacle having a first plurality of contacts arranged consistent with a first interface; and
an insert having a second plurality of contacts in a first arrangement;
wherein the second adapter comprises:
a receptacle having a third plurality of contacts arranged consistent with a second interface, the second interface different from the first interface; and
an insert having a fourth plurality of contacts in the first arrangement.

8. The plurality of adapters of claim 7 wherein the connector receptacle in the electronic device comprises a fifth plurality of contacts, wherein when the first adapter is inserted in a connector receptacle in the electronic device, each of the first plurality of contacts is electrically connected at least one of the fifth plurality of contacts, and at least one of the fifth plurality of contacts is not electrically connected to any of the first plurality of contacts.

9. The plurality of adapters of claim 8 wherein the first adapter comprises a magnet.

10. The plurality of adapters of claim 8 wherein the connector receptacle in the electronic device comprises a magnet.

11. The plurality of adapters of claim 8 wherein each of the plurality of adapters includes a keying feature on the insert.

12. The plurality of adapters of claim 8 wherein the receptacle of the first adapter may receive a universal serial bus insert.

13. A method of forming a connection between a cable and an electronic device, the method comprising:
determining a type of connector insert on an end of the cable to be connected to the electronic device;
selecting an adapter from a plurality of adapters, where each adapter in the plurality of adapters includes a receptacle to accept a connector insert, where each adapter accepts a different type of connector insert;
inserting the connector insert on the end of the cable into the receptacle in the selected adapter and inserting a connector insert portion of the adapter into a connector receptacle in the electronic device, wherein the receptacle in the electronic device may accept the connector insert portion on each adapter in the plurality of adapters.

14. The method of claim 13 wherein the selected adapter further comprises a first plurality of contacts in the receptacle and the connector receptacle in the electronic device comprises a second plurality of contacts, wherein when the selected adapter is inserted in the connector receptacle in the electronic device, each of the first plurality of contacts is electrically connected at least one of the second plurality of contacts, and at least one of the second plurality of contacts is not electrically connected to any of the first plurality of contacts.

15. The method of claim 13 wherein the selected adapter comprises a magnet.

16. The method of claim 13 wherein the connector receptacle in the electronic device comprises a magnet.

17. The method of claim 13 wherein each of the plurality of adapters includes a keying feature on the insert.

18. The method of claim 13 wherein the receptacle of the selected adapter may receive a universal serial bus insert.

19. A connector adapter comprising:
a front face having an opening for a connector receptacle;
a rear face comprising:
a rear curved face forming an arc from a left edge of the front face of the adapter to a right edge of the front face of the adapter;
a top surface downwardly sloping from a top edge of the front face of the adapter to a top of the rear curved surface; and
a bottom surface upwardly sloping from a bottom edge of the front face of the adapter to a bottom of the rear curved surface.

20. The connector adapter of claim 19 further comprising:
a keying feature on the rear curved face of the adapter.
